(19) United States
(12) Patent Application Publication
(10) Pub. No.: US 2016/0323600 A1
(43) Pub. Date: Nov. 3, 2016

(54) Methods and Apparatus for Use of Adaptive Prediction Resolution in Video Coding

(71) Applicant: Zhan Ma, Fremont, CA (US)

(72) Inventor: Zhan Ma, Fremont, CA (US)

(21) Appl. No.: 15/143,624

(22) Filed: May 1, 2016

Related U.S. Application Data
(60) Provisional application No. 62/155,450, filed on Apr. 30, 2015.

(51) Int. Cl. H04N 19/593; H04N 19/513; H04N 19/147; H04N 19/176; H04N 19/174; H04N 19/14

(52) U.S. Cl. CPC H04N 19/593; H04N 19/174; H04N 19/14; H04N 19/147; H04N 19/176; H04N 19/513

(57) ABSTRACT

A method and apparatus for use of an adaptive prediction resolution in video coding is disclosed. One or more adaptive flags are provided in one or more syntaxes of a prediction scheme in encoding and decoding video signals. In one embodiment, the adaptive flags are suitable to indicate whether a subset or a full set of intra prediction modes is used at a slice level or a coding block level. In one embodiment, the adaptive flags are suitable to indicate whether integer or fractional motion vector resolution is used at a slice level or a coding block level.

### CROSS-REFERENCE TO RELATED APPLICATIONS

This application claims the benefit of the filing date of the following U.S. Provisional Application, which is hereby incorporated by reference in its entirety for all purposes: Ser. No. 62/155,450, filed on Apr. 30, 2015, and titled “Methods and Apparatus for Use of Adaptive Prediction Resolution in Video Coding.”

### TECHNICAL FIELD

This invention relates generally to video encoding and decoding, and more specifically, to a method and an apparatus for video encoding and decoding with adaptive prediction resolution.

### BACKGROUND

Screen content is normally generated from the frame buffer of the computer or any Graphics User Interface (GUI) capable devices, for instance, mobile phone screens. A typical screen picture mixes discontinuous-tone content such as text, icon, and graphics, and continuous-tone content such as video sequences and images with natural content. Continuous-tone and discontinuous-tone content generally have quite different statistical distributions. For instance, pixels in continuous-tone content involve smaller intensity changes among local neighbors while neighboring pixel intensity could vary unexpectedly for discontinuous-tone samples. Further, discontinuous-tone content likely contains less distinct colors than the rich color distribution in continuous-tone content. On the other hand, local samples of continuous-tone content typically present more complicated textures and orientations compared with the discontinuous-tone content.

Fractional motion vector resolution has been used in video coding of camera captured natural video content and has achieved gains in coding efficiency. Slice-level integer motion vector resolution was introduced in the screen content coding extension of High-Efficiency Video Coding (HEVC), and it has demonstrated a noticeable coding efficiency improvement.

### BRIEF SUMMARY

The present principles relate to encoding and/or decoding a video signal, specifically to using adaptive prediction resolution in video coding.

In one embodiment, a method for encoding a video signal is disclosed. Said method comprises providing an adaptive flag in a syntax of a prediction scheme, the adaptive flag being suitable to indicate whether a subset or a complete set of 35 HEVC intra prediction modes is used. The adaptive flag provided in this method is further suitable to indicate whether a subset or a complete set of 35 HEVC intra prediction modes is used at a slice level or at a block level. Whether a subset or a complete set of 35 HEVC intra prediction modes is used at the slice level is determined based on pre-processing of the slice using an algorithm, the algorithm includes dominant edge detection, the brute-force rate-distortion optimized (RDO) search, and other complexity measurement algorithm; and whether a subset or a complete set of 35 HEVC intra prediction modes is used at the coding block level is determined based on an algorithm, the algorithm includes dominant edge detection, the brute-force rate-distortion optimized (RDO) search, and other complexity measurement algorithm. The adaptive flag suitable to indicate whether a subset or a complete set of 35 HEVC intra prediction modes is used at the slice level or the coding block level can be included in a slice segment header, coding units or other enhancement messages, such as SEI, in accordance with the present principles.

In one embodiment, a method is disclosed for decoding a video signal, comprising parsing an adaptive flag in a syntax of a prediction scheme, said adaptive flag being suitable to indicate whether a subset or a full set of 35 HEVC intra prediction modes is used. The adaptive flag provided in said method is further suitable to indicate whether a subset or a complete set of 35 HEVC intra prediction modes is used at a slice level or at a coding block level. When the adaptive flag indicates a subset or a complete set of 35 HEVC intra prediction modes is used at the slice level, said method for decoding a video signal further retrieves and applies the slice-level intra prediction modes. When the adaptive flag indicates a subset or a complete set of 35 HEVC intra prediction modes is used at the coding block level, said method further decodes and applies the coding-block-level intra predication modes.

In one embodiment, a method is disclosed for encoding a video signal, comprising providing an adaptive flag in a syntax of a prediction scheme, the adaptive flag being suitable to indicate whether integer or fractional motion vector resolution is used. Said adaptive flag in the method is further suitable to indicate whether integer or fractional motion vector resolution is used at a slice level or at a coding blocking level. Whether integer or fractional motion vector resolution is used at the slice level is based on pre-processing of the slice using an algorithm, said algorithm includes the brute-force rate-distortion optimized (RDO) search, fast decision using fast decision using the MAD (Mean Absolute Difference), the SSD (Sum of Squared Difference) and other complexity measurement algorithm. Whether integer or fractional motion vector resolution is used at the coding blocking level is based on an algorithm, said algorithm includes the brute-force rate-distortion optimized (RDO) search, fast decision using fast decision using the MAD (Mean Absolute Difference), the SSD (Sum of Squared Difference) and other complexity measurement algorithm. The adaptive flag suitable to indicate whether integer or fractional motion vector resolution is used can be included in a slice segment header, coding units or other enhancement messages, such as SEI, in accordance with the present principles.

In one embodiment, a method is disclosed for decoding a video signal, comprising parsing an adaptive flag in a syntax of a prediction scheme, the adaptive flag being suitable to indicate whether integer or fractional motion vector resolution is used. The adaptive flag provided in said method is further suitable to indicate whether integer or fractional motion vector resolution is used at a slice level or at the coding block level. When the adaptive flag indicates whether integer or fractional motion vector resolution is used at the slice level, said method further retrieves and applies the slice-level motion vector resolution. When the adaptive flag indicates whether integer or fractional motion vector resolution is used at the coding block level, said method for decoding a video signal further decodes and applies the coding-block-level motion vector resolution.

In one embodiment, an encoder is disclosed wherein a method for encoding a video signal is applied, said method comprising providing an adaptive flag in a syntax of a prediction scheme, the adaptive flag being suitable to indicate whether a subset or a complete set of 35 HEVC intra prediction modes is used. The adaptive flag provided in this method is further suitable to indicate whether a subset or a complete set of 35 HEVC intra prediction modes is used at a slice level or at a block level. Whether a subset or a complete set of 35 HEVC intra prediction modes is used at the slice level is determined based on pre-processing of the slice using an algorithm, the algorithm includes dominant edge detection, the brute-force rate-distortion optimized (RDO) search, and other complexity measurement algorithm; and whether a subset or a complete set of 35 HEVC intra prediction modes is used at the coding block level is determined based on an algorithm, the algorithm includes dominant edge detection, the brute-force rate-distortion optimized (RDO) search, and other complexity measurement algorithm. The adaptive flag suitable to indicate whether a subset or a complete set of 35 HEVC intra prediction modes is used at the slice level or the coding block level can be included in a slice segment header, coding units or other enhancement messages, such as SEI, in accordance with the present principles.

In one embodiment, a decoder is disclosed wherein a method for decoding a video signal is applied, said method comprising parsing an adaptive flag in a syntax of a prediction scheme, said adaptive flag being suitable to indicate whether a subset or a full set of 35 HEVC intra prediction modes is used. The adaptive flag provided in said method is further suitable to indicate whether a subset or a complete set of 35 HEVC intra prediction modes is used at a slice level or at a coding block level. When the adaptive flag indicates a subset or a complete set of 35 HEVC intra prediction modes is used at the slice level, said method for decoding a video signal further retrieves and applies the slice-level intra prediction modes. When the adaptive flag indicates a subset or a complete set of 35 HEVC intra prediction modes is used at the coding block level, said method further decodes and applies the coding-block-level intra predication modes.

In one embodiment, an encoder is disclosed wherein a method for encoding a video signal is applied, said method comprising providing an adaptive flag in a syntax of a prediction scheme, the adaptive flag being suitable to indicate whether integer or fractional motion vector resolution is used. Said adaptive flag in the method is further suitable to indicate whether integer or fractional motion vector resolution is used at a slice level or at a coding blocking level. Whether integer or fractional motion vector resolution is used at the slice level is based on pre-processing of the slice using an algorithm, said algorithm includes the brute-force rate-distortion optimized (RDO) search, fast decision using fast decision using the MAD (Mean Absolute Difference), the SSD (Sum of Squared Difference) and other complexity measurement algorithm. Whether integer or fractional motion vector resolution is used at the coding blocking level is based on an algorithm, said algorithm includes the brute-force rate-distortion optimized (RDO) search, fast decision using fast decision using the MAD (Mean Absolute Difference), the SSD (Sum of Squared Difference) and other complexity measurement algorithm. The adaptive flag suitable to indicate whether integer or fractional motion vector resolution is used can be included in a slice segment header, coding units or other enhancement messages, such as SEI, in accordance with the present principles.

In one embodiment, a decoder is disclosed, wherein a method for decoding a video signal is applied, said method comprising parsing an adaptive flag in a syntax of a prediction scheme, the adaptive flag being suitable to indicate whether integer or fractional motion vector resolution is used. The adaptive flag provided in said method is further suitable to indicate whether integer or fractional motion vector resolution is used at a slice level or at the coding block level. When the adaptive flag indicates whether integer or fractional motion vector resolution is used at the slice level, said method further retrieves and applies the slice-level motion vector resolution. When the adaptive flag indicates whether integer or fractional motion vector resolution is used at the coding block level, said method for decoding a video signal further decodes and applies the coding-block-level motion vector resolution.

### BRIEF DESCRIPTION OF THE DRAWINGS

FIG. 1 is a diagram illustrating an encoding process, according to an exemplary embodiment of the present principles;

FIG. 2 is a flow diagram illustrating an exemplary method for performing adaptive motion vector resolution selection, according to an exemplary embodiment of the present principles;

FIG. 3 is a flow diagram illustrating an exemplary method for performing adaptive intra resolution selection, according to an exemplary embodiment of the present principles;

FIG. 4 is a flow diagram illustrating a decoding method with adaptive prediction resolution, according to an exemplary embodiment of the present principles;

FIG. 5 is a diagram illustrating one exemplary configuration of an encoder wherein an exemplary embodiment of the present principles can be applied;

FIG. 6 is a diagram illustrating one exemplary configuration of a decoder wherein an exemplary embodiment of the present principles can be applied; and

FIG. 7 is a diagram illustrating various components that may be utilized in an exemplary embodiment of the electronic devices wherein the exemplary embodiment of the present principles can be applied.

### DETAILED DESCRIPTION

The present principles are directed to adaptive prediction resolution in video encoding and decoding. The present embodiments may further improve both inter coding and intra coding of the screen coding extension of HEVC for coding efficiency and reduces coding latency. In the present application, the term “prediction resolution” is used to refer to the motion vector (MV) resolution in inter coding, and to the adaptive intra resolution to select a subset of angular modes.

The following discusses various embodiments in the context of HEVC for screen content coding, and references the coding tree unit (CTU) used in HEVC when referring to a “coding block.” However, the present embodiments can be adapted to other video compression technologies, standards, recommendations and extensions thereof, and may also be applied to other types of video content in addition to screen content. The “coding block” is also not limited to CTU in HEVC, and can be of a different size or a different shape.

In one embodiment, the block-level adaptive motion vector (MV) resolution selection is described. For example, an integer-pel motion vector is used for one coding block, and a quarter-pel motion vector is used for another coding block in a slice. It will reduce the coding latency and improve the slice-level pipeline implementation. In addition, it will also improve the coding efficiency for content with mixed discontinuous-tone content and continuous-tone images or videos.

In another embodiment, the adaptive intra resolution further described below considers multiple intra prediction modes as a resolution measure and determines whether a subset of prediction modes for intra coding can be used to reduce computing resource consumption and to increase efficiency. As a comparison, HEVC intra prediction includes 35 different angular modes, which massively exploits the redundancy in natural camera capture video content. Screen content usually requires fewer prediction modes due to the homogeneous regions contained therein. In one embodiment of the present adaptive intra resolution selection, fewer modes (for example, DC, planar, Horizontal, Vertical and alike) can be used for homogenous regions in screen content and regular 35 modes can be used for regions with rich texture, thus increasing coding efficiency. This selection of a subset of prediction modes could be applied either at the slice level or the block level.

### Adaptive Motion Vector Resolution Selection

In accordance with the adaptive motion vector (MV) resolution selection, the motion vector inter resolution is configured to be adaptive at both the slice level and the CTU level. In one embodiment, three syntax elements are introduced in slice segment header—slice_adaptive_mv_resolution_enable_flag, slice_adaptive_mv_resolution, and CTU_adaptive_mv_resolution_enable_flag, and one new syntax element is introduced in the coding unit level—CTU_adaptive_mv_resolution, as further described below. Syntax elements using different names but serving the same functions can be included in slice segment header, coding units or other enhancement messages, such as SEI, in accordance with the present principles.

| slice_segment_header( ) | Descriptor |
|---|---|
| . . . | |
| slice_adaptive_mv_resolution_enable_flag | u(l) |
| if (slice_adaptive_mv_resolution_enable_flag ) | |
| slice_adaptive_mv_resolution_ | u(l) |
| else | |
| CTU_adaptive_mv_resolution_enable_flag | u(l) |
| . . . | |

| coding_unit (x0,y0, log2CbSize) { | Descriptor |
|---|---|
| CTU_adaptive_mv_resolution | ue(v) |
| . . . . | |
| } | |

Descriptor u(1) for the three syntax elements—slice_adaptive_mv_resolution_enable_flag, slice_adaptive_mv_resolution and CTU_adaptive_mv_resolution_enable_flag—is defined as unsigned integer using one bit. The parsing process for this descriptor is specified by the return value of the function reading this one bit, interpreted as a binary representation of an unsigned integer with most significant bit written first.

Descriptor ue(v) for the syntax element CTU_adaptive_mv_resolution is defined as unsigned integer zero order Exp-Golomb-coded syntax element with the left bit first. Note that Discriptors u(1) and ue(v) used here are exemplary. Other bit encoding methods can also be applied.

Syntax element slice_adaptive_mv_resolution_enable_flag equal to 1 (true) specifies that slice level motion vector resolution is selected, which depends on the syntax element slice_adaptive_mv_resolution. Syntax element slice_adaptive_mv_resolution_enable_flag equal to 0 (false) specifies that CTU level motion vector resolution will be selected.

Syntax element slice_adaptive_mv_resolution equal to 1 (true) specifies that the resolution of motion vectors for inter coding in the current slice is integer. Syntax element slice_adaptive_mv_resolution equal to 0 (false) specifies that the resolution of motion vectors for inter coding in the current slice is fractional. Syntax element slice_adaptive_mv_resolution according to the present embodiment is to indicate the slice-level MV control scheme in general. Different algorithms can be used to determine the value for the syntax slice_adaptive_mv_resolution, which indicates whether integer or fractional MV is used at the slice level. One such algorithm is the brute-force rate-distortion optimized (RDO) search. Alternative algorithms include for example fast decision using the slice content complexity measurement, such as block standard deviation distribution.

Syntax element CTU_adaptive_mv_resolution_enable_flag equal to 1 (true) specifies that CTU level motion vector resolution is selected, depending on the corresponding CTU level syntax element in coding units—CTU_adaptive_mv_resolution. Syntax element CTU_adaptive_mv_resolution_enable_flag equal to 0 (false) specifies that the resolution of motion vectors for inter coding in the current CTU is the same as the default value specified in HEVC.

Different algorithms can be used to determine the value for the syntax CTU_adaptive_mv_resolution, which indicates whether integer or fractional MV is used at the CTU level. One such algorithm is the brute-force rate-distortion optimized (RDO) search. Alternative algorithms include fast decision using the MAD (Mean Absolute Difference) or the SSD (Sum of Squared Difference).

If slice_adaptive_mv_resolution_enable_flag is true (1), CTU_adaptive_mv_resolution_flag is inferred as false (0). If slice_adaptive_mv_resolution_enable_flag is false (0), CTU_adaptive_mv_resolution_enable_flag is used to apply the block level MV resolution. If slice_adaptive_mv_resolution_enable_flag is false (0) and CTU_adaptive_mv_resolution_enable_flag is true (1), the CTU level syntax element in coding units—CTU_adaptive_mv_resolution will determine the block level MV resolution If both CTU_adaptive_mv_resolution_enable_flag and slice_adaptive_mv_resolution_enable_flag are false (0), it will follow the conventional process to decide the appropriate MV resolution at the CTV as descried in the HEVC standard.

Screen content may include video, image, graphics, texts, icons, and others. Applying a single fixed MV resolution for all regions in a slice cannot achieve the desired coding efficiency. Using a slice-level fixed MV resolution also likely introduces slice-level structural delay. CTU adaptive MV resolution selection can be harmonized with CTU pipeline without introducing additional delay. The adaptive MV resolution selection with integer and fractional accuracy at slice or CTU level described above results in improved coding efficiency of screen content.

### Adaptive Intra Resolution

Another significant part in video coding is intra prediction. Intra prediction in HEVC uses 33 angular prediction modes and two additional prediction modes (DC and planar) at each depth. This presents a big challenge for chip designers and manufacturers due to its massive computing requirement and limited parallel processing capability due to high neighboring data dependency.

While 35 prediction modes as defined in the HEVC standard is beneficial for intra coding of the natural video/image with more fine details, this standard intra coding solution does not lead to same benefits for screen content, because of the homogeneous regions therein that require less fine details for comparable visual quality. This standard intra coding solution also consumes significant computing resources and creates latency. In one exemplary embodiment of the adaptive intra resolution selection, a subset of intra coding modes are selected for each block for each depth of screen contents, including for example, DC, planar, H, V, and 45 degree. With preprocessing to identify the dominant angular modes (or textures) in each CTU, only certain selected modes are used for adaptive intra prediction. In one exemplary embodiment, prediction modes of DC, planar, H, V are identified as the dominant angular modes and are selected by the CTU or slice level adaptive intra resolution. Different numbers and combinations of prediction modes can be included for intra resolution according to the present principles.

In accordance with one example of the adaptive intra resolution selection, four new syntax elements can be introduced and defined in the slice segment header—slice_adaptive_intra_enable_flag, num_of_slice_select_intra_modes, slice_select_intra_modes and CTU_adaptive_intra_enable_flag, and two new syntax elements are introduced and defined in the coding unit level—num_of_CTU_select_intra_modes, CTU_select_intra_modes, as further described below. Syntaxes elements of different names serving the same functions can be included in the slice segment header, coding units or other enhancement messages, such as SEI, in accordance with the present principles.

| slice_segment_header( ) | Descriptor |
|---|---|
| . . . | |
| slice_adaptive_intra_enable_flag | u(l) |
| if (slice_adaptive_intra_enable_flag ) { | |
| num_of_slice_select_intra_modes | u(v) |
| for (i=0;i< num_of_slice_select_intra_modes;i++) | |
| slice_select_intra_modes[i] | ue(v) |
| }else | |
| CTU_adaptive_intra_enable_flag | u(l) |
| . . . . | |

| coding_unit (x0,y0, log2CbSize) { | Descriptor |
|---|---|
| . . . | |
| num_of_CTU_select_intra_modes | u(v) |
| for (i=0;i<num_of_CTU_select_intra_modes;i++) | |
| CTU_select_intra_modes[i] | ue(v) |
| . . . | |

Descriptor u(1) for the two syntax elements—slice_adaptive_intra_enable_flag and CTU_adaptive_intra_enable_flag—is defined as unsigned integer using one bit. The parsing process for this descriptor is specified by the return value of the function reading this one bit, interpreted as a binary representation of an unsigned integer with most significant bit written first.

Descriptor u(v) for two syntax elements—num_of_slice_select_intra_modes and num_of_CTU_select_intra_modes—is defined as unsigned integer using v bits. The parsing process for this descriptor is specified by the return value of the function reading these v bit, interpreted as a binary representation of an unsigned integer with most significant bit written first.

Descriptor ue(v) for the two syntax elements—slice_select_intra_mode and CTU_select_intra_modes—is defined as unsigned integer zero order Exp-Golomb-coded syntax element with the left bit first.

Syntax element slice_adaptive_intra_enable_flag equal to 1 (true) specifies that the resolution of intra modes (number of selected intra modes) for intra coding is adaptive at the slice level. Syntax element slice_adaptive_intra_enable_flag equal to 0 (false) specifies that the resolution of intra modes for intra coding is not adaptive at the slice level.

Syntax element num_of_slice_select_intra_modes specifies the number of intra modes selected for intra prediction in this slice.

Syntax element slice_select_intra_modes specifies the particular intra modes selected for the slice. These modes can be transmitted explicitly as exemplified in above table. They can also be transmitted using the mapped indices with the original HEVC intra modes.

Different algorithms can be used to determine the value for the syntax num_of_slice_select_intra_modes, and slice_select_intra_modes. One exemplary algorithm is the dominant edge detection to identify fewer most significant directions in this slice. Alternative algorithms include brute-force rate-distortion optimized (RDO) search, and other complexity measurement algorithm.

CTU_adaptive_intra_enable_flag equal to 1 (true) specifies that the resolution of intra modes for intra coding is CTU adaptive. CTU_adaptive_intra_enable_flag equal to 0 (false) specifies that the resolution of intra modes for intra coding in the current CTU is the same as the default solution specified in HEVC.

Syntax element num_of_CTU_select_intra_modes specifies the number of intra modes selected for prediction in this CTU.

Syntax element CTU_select_intra_modes specifies the particular intra modes selected for this CTU. These modes can be transmitted explicitly as exemplified in above table. They can also be transmitted using the mapped indices with the original HEVC intra modes.

Different algorithms can be used to determine the value for the syntax elements num_of_CTU_select_intra_modes, and CTU_select_intra_modes. One exemplary algorithm is the dominant edge detection to identify fewer most significant directions in this CTU. Alternative algorithms include brute-force rate-distortion optimized (RDO) search, and other complexity measurement algorithm.

If slice_adaptive_intra_enable_flag is true (1), CTU_adaptive_intra_enable_flag is inferred as 0 and the slice-level intra resolution indicated in the syntax elements—num_of_slice_select_modes and slice_select_modes—is applied to all CTUs in this slice. If slice_adaptive_intra_enable_flag is false (0), CTU_adaptive_intra_enable_flag is used to control the block level intra mode resolution. If CTU_adaptive_intra_enable_flag is true (1), num_of_CTU_select_modes and CTU_select_intra_modes are used to explicitly signal the intra resolution for this CTU. If both CTU_adaptive_intra_enable_flag and slice_adaptive_intra_enable_flag are false (0), it will follow the conventional process to decide the appropriate intra modes at the coding unit level as descried in the HEVC standard.

Further, instead of applying the uniform intra modes for different coding unit sizes, block-size adaptive intra modes can be used to apply different subsets of intra modes for different coding unit sizes thus to further increase the coding efficiency.

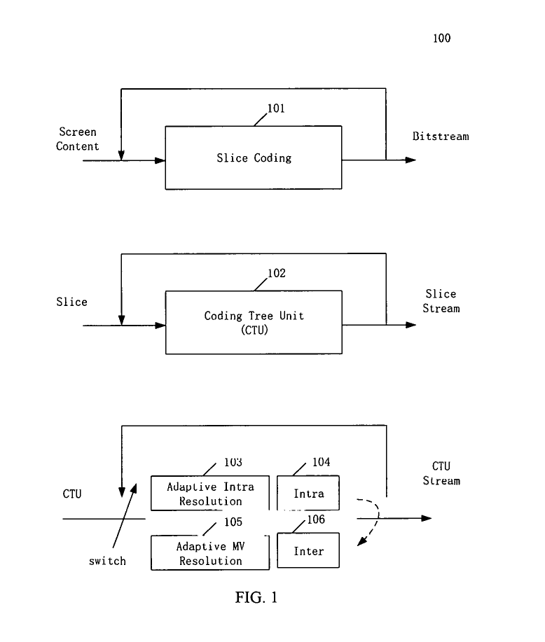

FIG. 1 illustrates an encoding process, according to an exemplary embodiment of the present principles. The encoder performs adaptive intra resolution to select intra modes (103) before intra coding (104), and the encoder also performs adaptive MV resolution to determine the MV resolution (105) before performing inter coding (106). Then the inter or intra mode is selected, for example, based on the RD cost or fast decision methods, to generate a CTU stream. At the slice level, all CTUs are encoded (102) to generate a slice stream. Then at a sequence level, the encoder encodes (101) all slices, for example, of a screen content, to generate the output bitstream.

In the following, the adaptive intra resolution selection and the adaptive MV resolution selection are described in further details.

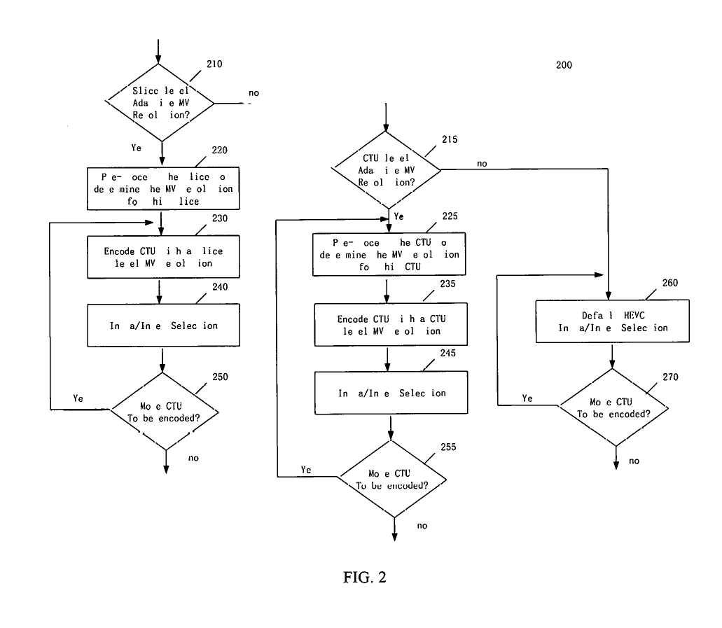

FIG. 2 illustrates an exemplary method 200 for performing adaptive MV resolution selection, according to an exemplary embodiment of the present principles. At step 210, an encoder checks whether the MV resolution is adaptive at a slice level, for example, by checking the relevant syntax element, such as slice_adaptive_mv_resolution_enable_flag, as defined above. If such syntax element is true, the encoder will pre-process the slice to determine which MV resolution (for example, integer-pel, half-pel, quarter-pel, or ⅛^{th}-pel), is used for the slice at step 220 and indicates such in a syntax element, for example, slice_adaptive_mv_resolution. A CTU within the slice is then encoded with the indicated slice-level MV resolution at step 230. Based on the inter coding (230) results and intra coding results, the encoder chooses intra or inter coding mode for the CTU at step 240. At step 250, the encoder checks whether there are more CTUs to be encoded for the slice. If yes, the control is returned to step 230. Otherwise, the encoding of the slice is completed.

When the encoder determines that the MV resolution is not adaptive at a slice level, for example, when the relevant syntax element, such as slice_adaptive_mv_resolution_enable_flag as defined above, is false, the encoder checks whether the MV resolution is adaptive at a CTU level at step 215 by checking whether the relevant syntax element, for example, CTU_adaptive_mv_resolution_enable_flag as defined above is true. If yes, the encoder determines the MV resolution for a current CTU at step 225, for example, by checking the value of the relevant syntax element, such as CTU_adaptive_mv_resolution as defined above, and encodes the current CTU with the CTU-level MV resolution at step 235. Based on the inter coding (235) results and Intra coding results, the encoder chooses intra or inter coding mode for the CTU at step 245. At step 255, the encoder checks whether there are more CTUs to be encoded for the slice. If yes, the control is returned to step 225. Otherwise, the encoding of the slice is completed.

When the encoder determines that the MV resolution is not adaptive at a slice level, or at a CTU level, for example, when the relevant syntax elements such as slice_adaptive_mv_resolution_enable_flag and CTU_adaptive_mv_resolution_enable_flag are both false, the encoder chooses intra or inter coding mode for the CTU at step 260 through default HEVC CTU intra/inter coding solution. At step 270, the encoder checks whether there are more CTUs to be encoded for the slice. If yes, the control is returned to step 260. Otherwise, the encoding of the slice is completed.

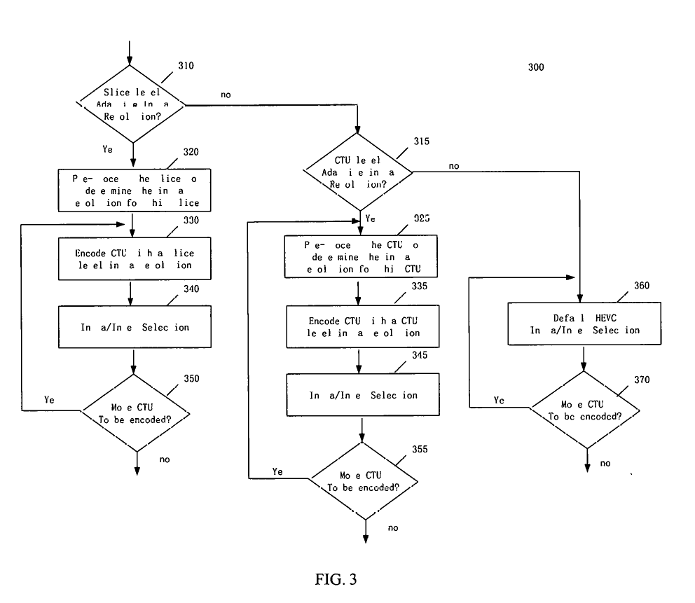

FIG. 3 illustrates an exemplary method 300 for performing adaptive intra resolution selection, according to an exemplary embodiment of the present principles. At step 310, an encoder checks whether the intra resolution is adaptive at a slice level, for example, by checking whether the relevant syntax element, such as slice_adaptive_intra_enable_flag as defined above is true. If yes, the encoder pre-processes the slice using algorithms such as RD optimization or dominant edge detection to determine what intra resolution, including the number of dominant intra prediction directions and the explicit or implicit intra prediction modes, is used for the slice at step 320 and indicates such in the relevant syntax elements such as num_of_slice_select_intra_modes and slice_select_intra_modes as defined above. A CTU within the slice is then encoded with the indicated slice-level intra resolution at step 330. Based on the inter coding (230) results and intra coding (330) results, the encoder chooses intra or inter coding mode for the CTU at step 340. At step 350, the encoder checks whether there are more CTUs to be encoded for the slice. If yes, the control is returned to step 330. Otherwise, the encoding of the slice is completed.

When the encoder determines that the intra resolution is not adaptive at a slice level, for example, when the relevant syntax element, such as slice_adaptive_intra_enable_flag as defined above is false, the encoder checks whether the intra resolution is adaptive at a CTU level at step 315, by for example checking whether the relevant syntax element, such as CTU_adaptive_intra_enable_flag as defined above is true. If yes, the encoder processes the present CTU using algorithms such as RD optimization or dominant edge detection to determine what intra resolution, including the number of dominant intra prediction directions and the explicit or implicit intra prediction modes, is used for the current CTU at step 325 and indicates it in the relevant syntax elements, such as num_of_CTU_select_intra_modes and CTU_select_intra_modes as defined above. The present CTU is then encoded with the CTU-level intra resolution at step 335. Based on the inter coding (235) results and intra coding results (335), the encoder chooses intra or inter coding mode for the CTU at step 345. At step 355, the encoder checks whether there are more CTUs to be encoded for the slice. If yes, the control is returned to step 325. Otherwise, the encoding of the slice is completed.

When the encoder determines that the intra resolution is not adaptive at a slice level, or at a CTU level, for example, when the relevant syntax elements, such as slice_adaptive_intra_enable_flag and CTU_adaptive_intra_enable_flag are both false, the encoder chooses intra or inter coding mode for the CTU at step 360 according to the default HEVC CTU intra/inter coding solution. At step 370, the encoder checks whether there are more CTUs to be encoded for the slice. If yes, the control is returned to step 360. Otherwise, the encoding of the slice is completed.

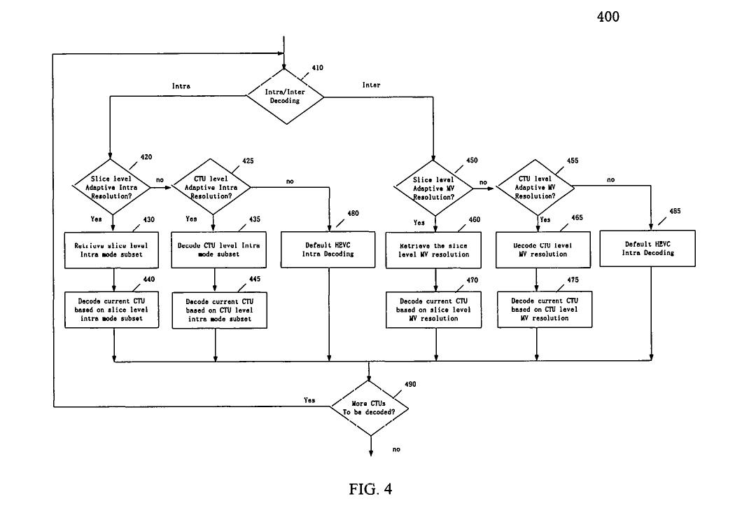

FIG. 4 illustrates a decoding method 400 with adaptive prediction resolution, according to an exemplary embodiment of the present principles. At step 410, a decoder checks whether intra or inter coding is used for a current CTU. If intra coding is used, the decoder checks, at step 420, the syntax element that indicates whether slice-level adaptive intra resolution is used, for example slice_adaptive_intra_enable_flag as defined above. If the slice-level adaptive intra resolution is used, for example, when slice_adaptive_intra_enable_flag is true, the decoder at step 430 retrieves the slice-level intra resolution information by checking the relevant syntax elements, for example num_of_slice_select_intra_modes, and slice_select_intra_modes as defined above, which can be included in the slice segment header. At 440, the decoder decodes the current CTU using the retrieved slice-level intra resolution. If the slice level adaptive intra resolution is not used, for example, when slice_adaptive_intra_enable_flag is false, at step 425, the decoder parses the relevant syntax element, for example CTU_adaptive_intra_enable_flag as defined above to determine whether CTU level adaptive intra resolution is used. If the CTU level adaptive intra resolution is used, such as when CTU_adaptive_intra_enable_flag is true, the decoder at step 435 decodes the intra modes resolution for the CTU by for example checking the relevant syntax elements, such as num_of_CTU_select_intra_modes, and CTU_select_intra_modes. At step 445, the current CTU is then decoded using the determined CTU-level intra resolution. If the syntax element indicating whether CTU-level adaptive intra prediction is used, such as slice_adaptive_intra_enable_flag, is false and the syntax element indicating whether slice-level adaptive intra prediction is used, such as CTU_adaptive_intra_enable_flag, is also false, the decoder performs the default HEVC intra decoding at step 480. At step 490, the encoder checks whether there are more CTUs to be decoded for the slice. If yes, the control is returned to step 410. Otherwise, the decoding of the slice is completed.

If inter coding is used for the current CTU, the decoder checks at step 450 whether the MV resolution is adaptive at a slice level, for example, by checking whether the relevant syntax element, such as slice_adaptive_mv_resolution_enable_flag as defined above, is true. If yes, the decoder, at step 460, retrieves the slice-level MV resolution by for example checking the relevant syntax element, such as slice_adaptive_mv_resolution as defined above. The CTU is then decoded using the retrieved slice-level MV resolution at step 470. If the relevant syntax element indicates the MV resolution is not adaptive at a slice level, such as when slice_adaptive_mv_resolution_enable_flag is false, the decoder checks whether the MV resolution is adaptive at a CTU level at step 455, for example, by checking whether the relevant syntax element, such as CTU_adaptive_mv_resolution_enable_flag as defined above is true. If yes, the MV resolution for the current CTU is decoded at step 465 by checking the relevant syntax element, such as CTU_adaptive_mv_resolution. At step 475, the decoder decodes the CTU using the decoded MV resolution. If the MV resolution is not adaptive at the slice level or CTU level, for example, when the syntax elements slice_adaptive_mv_resolution_enable_flag and CTU_adaptive_mv_resolution_enable_flag are both false, the default HEVC inter decoding is used to decode modes, motion vectors, and coefficients at step 485. At step 490, the encoder checks whether there are more CTUs to be decoded for the slice. If yes, the control is returned to step 410. Otherwise, the decoding of the slice is completed.

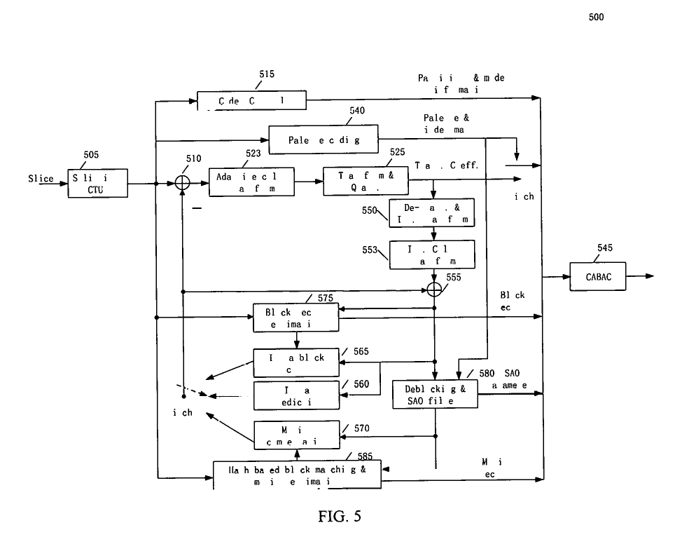

FIG. 5 illustrates an exemplary encoder 500 wherein the present embodiments can be applied. The input of apparatus 500 includes a video to be encoded. In the exemplary encoder 500, a picture to be encoded is split into CTUs 505 and is processed in units of CTUs. Each CTU is encoded using either an intra, or palette, or intra block copy or inter mode. When a CTU is encoded in an intra mode, it performs intra prediction 560. In an inter mode, the CTU performs motion estimation 585 and compensation 570.

In a palette mode, the CTU performs palette and corresponding index map coding 540. In an intra block copy mode, the CTU performs block matching 575 and copy 565. The encoder decides which one of them to use for encoding the coding unit 515, and prediction residuals are calculated by subtracting the predicted block from the original image block 510. The prediction residuals are then transformed and quantized at block 525. The quantized transform coefficients, as well as motion vectors and other syntax elements, are entropy coded in block 545 to output a bitstream.

The encoder decodes an encoded block to provide a reference for further predictions. The quantized transform coefficients are de-quantized and inverse transformed to decode prediction residuals at block 550. Combining the decoded prediction residuals and the predicted block 555, an image block is reconstructed. A filter or an image processor is applied to the reconstructed block or the reconstructed picture at 565, for example, to perform deblocking and SAO filtering to reduce blockiness artifacts.

The encoder performs the coder control to adapt the bit rate, modes at block 515. Color transform at block 523 is applied to reduce the redundancy between different color components when using RGB or even YUV full color sampling video resource. Inverse color transform is performed at block 553 to reconstruct the color components through inter-component prediction. Palette mode at block 540 is used to transform conventional pixel domain block into color table and indices for encoding. Hash based motion search at block 585 is applied to fast locate corresponding predictive block at reference buffer.

To integrate adaptive prediction resolution selection into encoder 500, the intra prediction module 560 would perform adaptive intra resolution selection as described in method 300, and the motion estimation module 570 would perform adaptive MV resolution selection as described in method 200.

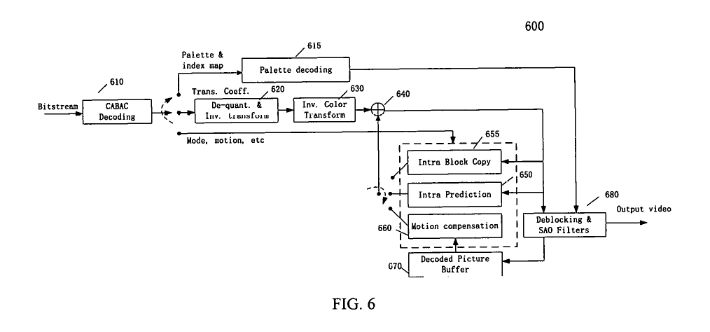

FIG. 6 depicts a block diagram of an exemplary video decoder 600 wherein the present embodiments can be applied. The input of apparatus 600 includes a video bitstream, which can be generated by video encoder 500.

In the exemplary decoder 600, the video bitstream is entropy decoded to have corresponding syntax elements at block 610. Inverse color transform 620, and dequantization and inverse transform 630 are performed to derive the prediction residuals. Residuals are added up at the predictive block 640. Each CTU is decoded using either an intra, or palette, or intra block copy or inter mode from the decode picture buffer at block 670. When a CTU is decoded in an intra mode, it performs intra prediction in block 650 for the neighbor pixel prediction. In an inter mode, the CTU performs motion compensation and block compensation in block 660. Palette mode is directly reconstructed using parsed indices and color table to have the reconstructed samples at block 615. Reconstructed block from Palette mode is sent to the deblocking and SAO filtering at block 680 to reduce the artefacts. Filtered samples are buffered for prediction through decoded picture buffer 670 or directly using intra block 655, intra 650 or inter 660 modes, or are sent to output.

To integrate adaptive prediction resolution selection into decoder 600, the intra prediction module 650 would perform the adaptive intra resolution selection and motion compensation module 660 would perform the adaptive MV resolution selection, as described in method 400.

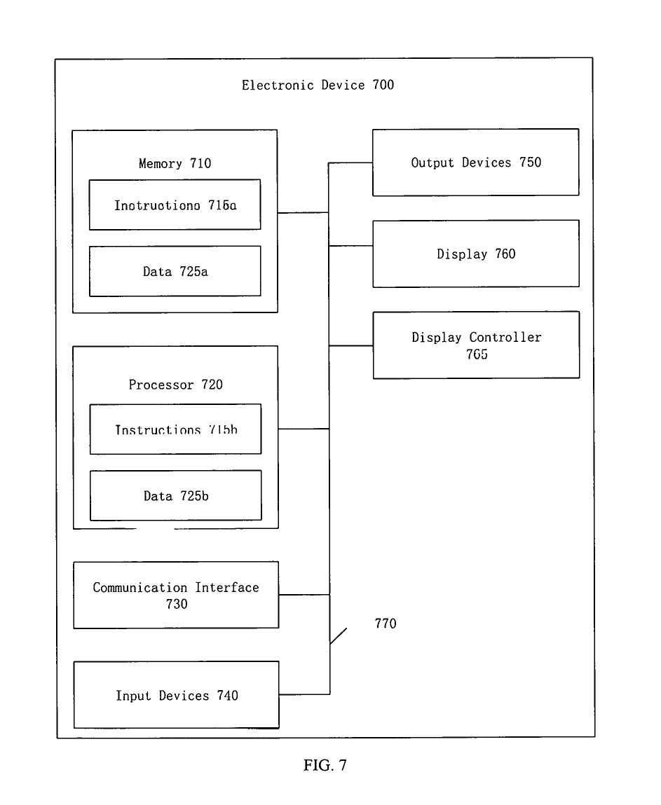

FIG. 7 illustrates various components that may be utilized in an electronic device 700. The electronic device 700 may be implemented as one or more of the electronic devices (e.g., electronic devices 500, 600) described previously.

The electronic device 700 includes at least a processor 720 that controls operation of the electronic device 700. The processor 720 may also be referred to as a CPU. Memory 710, which may include both read-only memory (ROM), random access memory (RAM) or any type of device that may store information, provides instructions 715a (e.g., executable instructions) and data 725a to the processor 720. A portion of the memory 710 may also include non-volatile random access memory (NVRAM). The memory 710 may be in electronic communication with the processor 720.

Instructions 715b and data 725b may also reside in the processor 720. Instructions 715b and data 725b loaded into the processor 720 may also include instructions 715a and/or data 725a from memory 710 that were loaded for execution or processing by the processor 720. The instructions 715b may be executed by the processor 720 to implement the systems and methods disclosed herein.

The electronic device 700 may include one or more communication interfaces 730 for communicating with other electronic devices. The communication interfaces 730 may be based on wired communication technology, wireless communication technology, or both. Examples of communication interfaces 730 include a serial port, a parallel port, a Universal Serial Bus (USB), an Ethernet adapter, an IEEE 1394 bus interface, a small computer system interface (SCSI) bus interface, an intrared (IR) communication port, a Bluetooth wireless communication adapter, a wireless transceiver in accordance with 3^{rd} Generation Partnership Project (3GPP) specifications and so forth.

The electronic device 700 may include one or more output devices 750 and one or more input devices 740. Examples of output devices 750 include a speaker, printer, etc. One type of output device that may be included in an electronic device 700 is a display device 760. Display devices 760 used with configurations disclosed herein may utilize any suitable image projection technology, such as a cathode ray tube (CRT), liquid crystal display (LCD), light-emitting diode (LED), gas plasma, electroluminescence or the like. A display controller 765 may be provided for converting data stored in the memory 710 into text, graphics, and/or moving images (as appropriate) shown on the display 760. Examples of input devices 740 include a keyboard, mouse, microphone, remote control device, button, joystick, trackball, touchpad, touchscreen, lightpen, etc.

The various components of the electronic device 700 are coupled together by a bus system 770, which may include a power bus, a control signal bus and a status signal bus, in addition to a data bus. However, for the sake of clarity, the various buses are illustrated in FIG. 7 as the bus system 770. The electronic device 700 illustrated in FIG. 7 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for encoding a video signal, comprising providing a flag in a syntax of an adaptive prediction scheme, the flag being suitable to indicate whether a subset or a complete set of intra prediction modes is used.

2. The method of claim 1, wherein said flag is suitable to indicate whether a subset or a complete set of intra prediction modes is used at a slice level.

3. The method of claim 2, wherein whether the subset or the complete set of intra prediction modes is used at the slice level is determined based on pre-processing of the slice using an algorithm, said algorithm includes at least one of dominant edge detection, brute-force rate-distortion optimized (RDO) search, and a complexity measurement algorithm.

4. The method of claim 1, wherein the flag is suitable to indicate whether a subset or a complete set of intra prediction modes is used at a coding block level.

5. The method of claim 4, wherein whether a subset or a complete set of intra prediction modes is used at the block level is determined based on an algorithm, said algorithm includes at least one of dominant edge detection, brute-force rate-distortion optimized (RDO) search, and a complexity measurement algorithm.

6. The method of claim 1, wherein said flag is included in a slice segment header.

7. The method of claim 1, wherein said intra prediction modes comprise HEVC intra prediction modes.

8. A method for decoding a video signal, comprising parsing a flag in a syntax of an adaptive prediction scheme, the flag being suitable to indicate whether a subset or a full set of intra prediction modes is used.

9. The method of claim 8, wherein said flag is suitable to indicate whether a subset or a complete set of intra prediction modes is used at a slice level.

10. The method of claim 9 further retrieves and applies the slice-level intra prediction modes for a current coding block, when said flag indicates a subset or a complete set of intra prediction modes is used at the slice level.

11. The method of claim 8, wherein said flag is suitable to indicate whether a subset or a complete set of intra prediction modes is used at a coding block level.

12. The method of claim 11 further decodes and applies the block-level intra prediction modes for a current coding block, when said flag indicates a subset or a complete set of intra prediction modes is used at the coding block level.

13. A method for encoding a video signal, comprising providing a flag in a syntax of an adaptive prediction scheme, the flag being suitable to indicate whether integer or fractional motion vector resolution is used.

14. The method of claim 13, wherein said flag is suitable to indicate whether integer or fractional motion vector resolution is used at a slice level.

15. The method of claim 14, wherein whether integer or fractional motion vector resolution is used at the slice level is based on pre-processing of the slice using an algorithm, said algorithm includes at least one of brute-force rate-distortion optimized (RDO) search, fast decision using fast decision using the MAD (Mean Absolute Difference), SSD (Sum of Squared Difference) and a complexity measurement algorithm.

16. The method of claim 13, wherein the flag is suitable to indicate whether integer or fractional motion vector resolution is used at a coding block level.

17. The method of claim 16, wherein whether integer or fractional motion vector resolution is used at the coding block level is based on an algorithm, said algorithm includes at least one of brute-force rate-distortion optimized (RDO) search, fast decision using fast decision using the MAD (Mean Absolute Difference), SSD (Sum of Squared Difference) and a complexity measurement algorithm.

18. The method of claim 13, wherein the flag is included in a slice segment header.

19. A method for decoding a video signal, comprising parsing a flag in a syntax of an adaptive prediction scheme, the flag being suitable to indicate whether integer or fractional motion vector resolution is used.

20. The method of claim 19, wherein the flag is suitable to indicate whether integer or fractional motion vector resolution is used at a slice level.

21. The method of claim 19, wherein the flag is suitable to indicate whether integer or fractional motion vector resolution is used at the coding block level.
